(19) United States
(12) Patent Application Publication
(10) Pub. No.: US 2011/0298150 A1
(43) Pub. Date: Dec. 8, 2011

(54) Insertion Of Metal Wire Elements In Artificial Stone

(76) Inventor: Gosakan Aravamudan, Bangalore (IN)

(21) Appl. No.: 13/201,624

(22) PCT Filed: Feb. 17, 2010
(86) PCT No.: PCT/IN10/00093

§ 371 Date: Aug. 16, 2011

(30) Foreign Application Priority Data
Feb. 20, 2009 (IN) 382/CHE/2009

(51) Int. Cl. B29C 39/10

(52) U.S. Cl. 264/162

(57) ABSTRACT

A method of inserting metal wire elements in an artificial stone is provided. One or more metal wire elements in multiple arrangements are placed on a surface. An uncured artificial stone mix is deposited on the metal wire elements and on the surface. The uncured artificial stone mix is allowed to cure at room temperature or at an elevated temperature and transformed into an artificial stone inserted with the metal wire elements. The artificial stone comprising the inserted metal wire elements is polished thereby generating a flat metal surface that visually implies metal inlay work. The metal wire elements may also be laid or adhered to a release layer deposited on the surface prior to depositing the uncured artificial stone mix. The metal wire used to create the metal wire elements comprises holes for secure anchoring in the artificial stone. The metal wire cross-section may be polygonal or circular.

### CROSS REFERENCE TO RELATED APPLICATIONS

This application claims the benefit of the following patent applications:

1. Provisional patent application number 382/CHE/2009 titled “Insertion Of Decorative Elements In Artificial Stone”, filed on Feb. 20, 2009 in the Indian Patent Office.

2. PCT application number PCT/IN2010/000093 titled “Insertion Of Metal Wire Elements In Artificial Stone”, filed on Feb. 17, 2010 in the Indian Patent Office.

The specifications of the above referenced patent applications are incorporated herein by reference in their entirety.

### BACKGROUND

This invention, in general, relates to decorating building structures. More particularly, this invention relates to inserting metal wire elements in an artificial stone.

If colored images are to be applied on wood, it has to be in the form of coatings. However, coatings on wood or its derivatives have a limited life. These coatings may discolor or peel off. Wood is not amenable to be worked into a variety of surface textures.

There is an unmet need for overcoming the above mentioned drawbacks associated with the existing materials used for manufacturing furniture. Moreover, there is a need for a long-standing structure as frequent replacements for doors, tables, and windows may be cumbersome and expensive.

Furthermore, there is a need for materials that possess properties, for example, abrasion resistance, dirt resistance, moisture resistance, shock resistance, fire resistance, frost resistance, thermal shock resistance, stain resistance, chemical resistance, and color permanence in order to achieve long durability.

Furthermore, there is an unmet need for a convenient process that enables insertion of decorative metal wire elements in artificial stone.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The method disclosed herein addresses the above stated need for inserting multiple metal wire elements in artificial stone. A metal wire is bent to a desired shape to create a metal wire element. The metal wire is, for example, a stainless steel wire, a copper wire, an aluminum wire, a brass wire, a metal alloy, etc. The cross-section of the metal wire is, for example, of a circular shape, an elliptical shape, a polygon shape, or a combination thereof. One or more metal wire elements in multiple different arrangements are placed on a surface. The arrangements may be of different patterns. An uncured artificial stone mix is deposited on the metal wire elements and on the surface. The uncured artificial stone mix further comprises particulates and resin. The particulates are composed of, for example, quartz, or composed of one or more of quartz, granite, glass, ceramic, etc. The uncured artificial stone mix is allowed to cure at room temperature or at an elevated temperature thereby transforming the uncured artificial stone mix into an artificial stone inserted with the metal wire elements. The artificial stone comprising the inserted metal wire elements is polished thereby generating a flat metal surface that visually implies metal inlay work.

The metal wire elements may also be laid or adhered to a release layer deposited on the surface prior to depositing the uncured artificial stone mix. The release layer is, for example, a polyethylene terephthalate sheet or polyvinyl alcohol coated on a substrate. A fiber and a resin may be applied on the uncured artificial stone mix deposited on the metal wire elements and the release layer. One or a combination of pressure, vibration, and a vacuum is applied on the deposited uncured artificial stone mix, whereby the uncured artificial stone mix is compacted and air entrapped in the uncured artificial stone mix is released. In an embodiment, the metal wire elements are arranged in the form of metal grids of multiple different patterns. The patterns are, for example, of a polygonal shape, a circular shape, etc. The metal grids provide improved tensile strength. The metal wire elements in the metal grid may be joined to each other, for example, by adhesion or mechanical fastening. The metal wire used to create the metal wire elements may comprise multiple holes to anchor the metal wire elements securely in the artificial stone. One or more metal wires with multiple holes used to create the metal wire elements may be linked through a solid wire passing through one or more holes to provide additional tensile strength to the artificial stone.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a method of inserting one or more metal wire elements in an artificial stone.

FIG. 2 exemplarily illustrates placement of metal wire elements on a release layer.

FIG. 3 exemplarily illustrates deposition of uncured artificial stone mix on the metal wire elements and on the release layer.

FIG. 4 exemplarily illustrates the artificial stone inserted with the metal wire elements.

FIG. 5 exemplarily illustrates a metal wire comprising multiple holes used to create the metal wire elements.

FIG. 6 exemplarily illustrates metal wire elements arranged in the form of a metal grid.

FIG. 7 exemplarily illustrates multiple metal wires comprising multiple holes linked through solid metal wires.

### DETAILED DESCRIPTION OF THE INVENTION

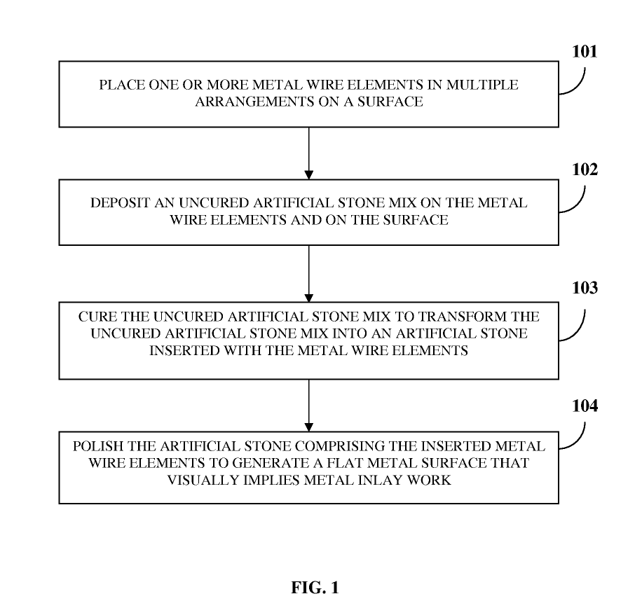

FIG. 1 illustrates a method of inserting one or more metal wire elements in an artificial stone. As used herein, the term “metal wire element” refers to a metal wire bent to a desired shape. The method disclosed herein comprises placing 101 one or more metal wire elements in multiple arrangements on a surface, depositing 102 an uncured artificial stone mix on the metal wire elements and on the surface, curing 103 the uncured artificial stone mix to transform the uncured artificial stone mix into an artificial stone inserted with the metal wire elements, and polishing 104 the artificial stone comprising the inserted metal wire elements to generate a flat metal surface that visually implies metal inlay work.

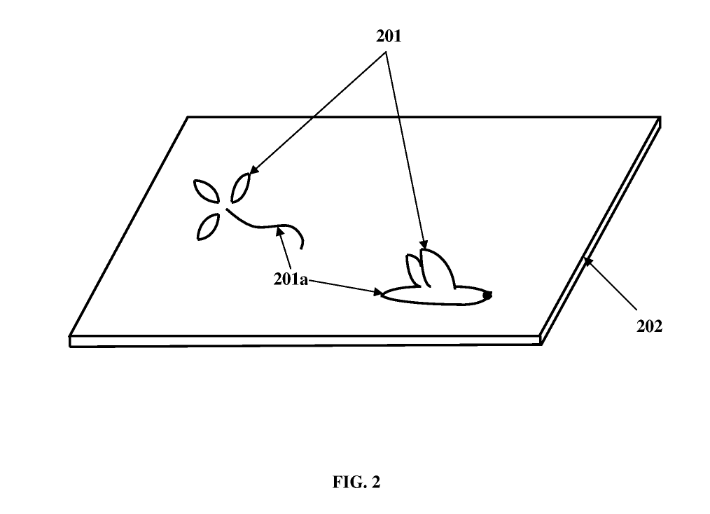

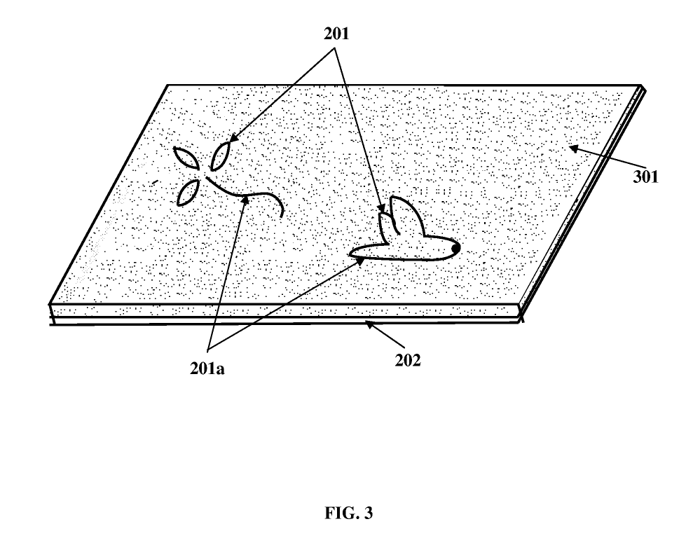

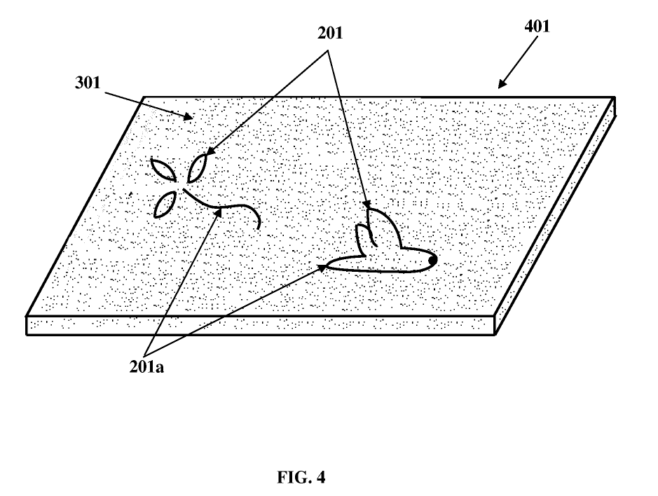

FIGS. 2-4 exemplarily illustrate manufacture of an artificial stone 401 inserted with metal wire elements 201. In an embodiment, a release layer 202 is provided. The metal wire elements 201 are laid or adhered to the release layer 202 prior to the deposition of the uncured artificial stone mix 301 on the metal wire elements 201 and on the release layer 202. A metal wire 201a with a predetermined cross-section is shaped to create the metal wire elements 201 and placed on the release layer 202. The metal wire 201a is, for example, a stainless steel wire, a copper wire, an aluminum wire, a brass wire, a metal alloy, etc. The release layer 202 is, for example, a polyethylene terephthalate sheet. Another example of the release layer 202 is polyvinyl alcohol coated on a substrate. The substrate is, for example, a glass surface. The placement of the metal wire elements 201 in a definite arrangement on the release layer 202 is exemplarily illustrated in FIG. 2. The uncured artificial stone mix 301 is deposited on the metal wire elements 201 and on the release layer 202 as exemplarily illustrated in FIG. 3. The uncured artificial stone mix 301 is allowed to cure at room temperature or at an elevated temperature and transformed into an artificial stone 401 inserted with the metal wire elements 201 as exemplarily illustrated in FIG. 4. Polishing after curing the uncured artificial stone mix 301 embedded with the metal wire elements 201 generates a flat metal surface that visually implies metal inlay work. The usual polishing techniques used for granite polishing may be applied. For example, an abrasive may be glued to a work wheel and the work wheel may be rotated to produce a polished surface. As a result of polishing, the circular cross-section, for example, of the metal wire 201a is flattened out and appears as a flat inlay to a viewer.

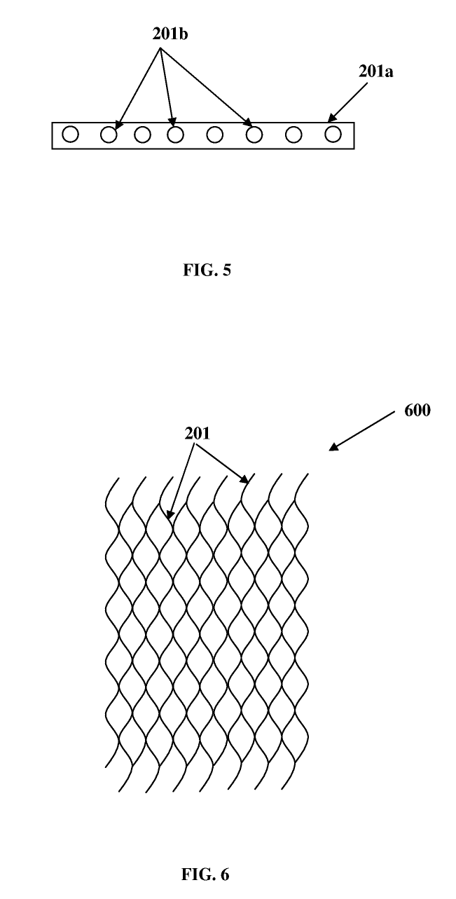

The cross-section of the metal wire 201a used to create the metal wire elements 201 is, for example, of a circular shape, an elliptical shape, a polygonal shape, and a combination thereof. For example, when metal wire elements 201 created using a metal wire 201a of a circular cross-section are embedded in the uncured artificial stone mix 301, a continuous flat metal surface is formed in the cured and polished artificial stone 401. In another example, when metal wire elements 201 created using a metal wire 201a of a star shape cross-section are embedded in the uncured artificial stone mix 301, a pair of parallel lines or a rectangular surface is formed in the cured and polished artificial stone 401. In another embodiment, the metal wire 201a comprises multiple holes 201b, as exemplarily illustrated in FIG. 5, to anchor the metal wire elements 201 securely in the artificial stone 401.

In another embodiment, multiple metal wire elements 201 are arranged in the form of metal grids 600 of multiple different patterns. FIG. 6 exemplarily illustrates metal wire elements 201 arranged in the form of a metal grid 600. The metal grid 600, as exemplarily illustrated in FIG. 6, is placed on the release layer 202. An uncured artificial stone mix 301 is deposited on the metal grid 600 and allowed to cure. The metal wire elements 201 arranged in the metal grid 600 reinforce the artificial stone 401 and improve the tensile strength of the artificial stone 401.

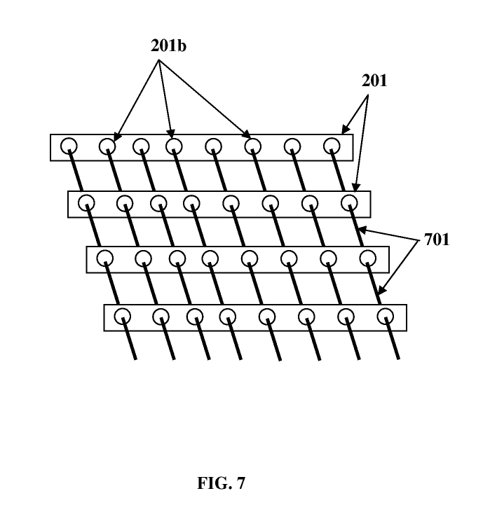

In yet another embodiment, the metal wire elements 201 comprising multiple holes 201b are linked through solid metal wires 701, wherein a single continuous solid metal wire 701 passes through multiple holes 201b as exemplarily illustrated in FIG. 7. The uncured artificial stone mix 301 is deposited on the linked metal wire elements 201 and cured. The linking of the metal wire elements 201 improves the tensile strength of the artificial stone 401.

The metal wire elements 201 may also be adhered to the release layer 202 by an adhesive. The adhesion between the artificial stone 401 and the metal wire elements 201 is greater than the adhesion between the metal wire elements 201 and the release layer 202. The uncured artificial stone mix 301 is deposited on the release layer 202 comprising one or more metal wire elements 201. Pressure may be applied on the deposited uncured artificial stone mix 301 for compaction. A backing of glass fiber and resin may be applied on the deposited uncured artificial stone mix 301. The fiber is, for example, a glass fiber or may be one of or a combination of glass fibers, carbon fibers, ceramic fibers, metal wires, and aramid yarn.

The uncured artificial stone mix 301 further comprises particulates and resin. The particulates are composed of, for example, quartz, or composed of one or more of quartz, granite, glass, ceramic, etc. The size of particulates may vary, for example, from a powder to 4 millimeters (mm). The size distribution may follow Fuller's formula so as to achieve maximum compaction. The resin is, for example, an unsaturated polyester resin. An example of an unsaturated polyester resin is a combination of iso-neopentyl glycol (80% by weight) and styrene (20% by weight). Another example of an unsaturated polyester resin is a combination of iso-neopentyl glycol, methyl acrylate, and styrene.

Room temperature catalysts, for example, methyl ethyl ketone peroxide (MEKP) and room temperature accelerators are used for curing. In another embodiment, high temperature setting catalysts, for example, dimethyl aniline (DMA), are used. In the uncured artificial stone mix 301, other ingredients, for example, dispersing agents, stabilizing agents, coupling agents, pigments, etc. are used for dispersion of fillers and pigments and for greater bonding between the fillers or reinforcements and the unsaturated polyester resin. The uncured artificial stone mix 301 may also be a cement based mix.

Tables 1-3 below are working examples of uncured artificial stone mix 301 compositions.

TABLE 1

| Ingredient | Parts by weight |
|---|---|
| Unsaturated Polyester resin (iso-neopentyl | 14 |
| glycol, styrene monomer, methyl | |
| methacrylate monomer) | |
| Quartz (particles size <4.0 mm) | 84 |
| Benzoyl peroxide | 1 |
| Dimethyl aniline (DMA) | 1 |

Curing is carried out at 70 deg C. for 15 minutes.

TABLE 2

| Ingredient | Parts by weight |
|---|---|
| Unsaturated Polyester resin (iso-neopentyl | 14 |
| glycol, styrene monomer) | |
| Quartz (particles size <3.0 mm) | 84 |
| Benzoyl peroxide | 1.0 |
| Dimethyl aniline (DMA) | 1.0 |

Curing is carried out at 70 deg C. for 15 minutes.

TABLE 3

| Ingredient | Parts by weight |
|---|---|
| Unsaturated Polyester resin (iso-neopentyl | 10 |
| glycol, styrene monomer, methyl | |
| methacrylate monomer) | |
| Quartz (particles size <4.0 mm) | 89 |
| Methyl ethyl ketone peroxide (MEKP) | 0.5 |
| Cobalt Naphthenate | 0.5 |

Curing is carried out at room temperature.

One or a combination of pressure, vibration, and a vacuum is applied on the deposited uncured artificial stone mix 301, whereby the deposited uncured artificial stone mix 301 is compacted, and air entrapped in the deposited uncured artificial stone mix 301 is released. The uncured artificial stone mix 301 may be vibro compacted using a vibrating compactor. A vacuum may also be applied for better compaction and removal of air cavities. The compacting pressure may be applied by a heavy roller or, the pressure is applied by a vibrating compactor. The vibrating compactor is a hydraulic or a pneumatic compactor that can apply high pressures. For example, the vibrating compactor may apply a pressure in the range of about 1 kg/cm² to about 10 kg/cm² on the artificial stone 401.

The foregoing examples have been provided merely for the purpose of explanation and are in no way to be construed as limiting of the invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

I claim:

1. A method of inserting a plurality of metal wire elements in an artificial stone, comprising:
placing one or more metal wire elements in a plurality of arrangements on a surface;
depositing an uncured artificial stone mix on said one or more metal wire elements and on said surface;
curing said uncured artificial stone mix, whereby said uncured artificial stone mix is transformed into said artificial stone inserted with said one or more metal wire elements; and
polishing said artificial stone comprising said inserted metal wire elements, whereby said polishing generates a flat metal surface that visually implies metal inlay work.

2. The method of claim 1, further comprising providing a release layer, and one of laying and adhering said one or more metal wire elements to said release layer prior to said deposition of said uncured artificial stone mix on said one or more metal wire elements and on said release layer.

3. The method of claim 2, further comprising applying a fiber and a resin on said uncured artificial stone mix deposited on said one or more metal wire elements and said release layer.

4. The method of claim 1, wherein cross-section of a metal wire used to create said one or more metal wire elements is in one of a circular shape, an elliptical shape, a polygonal shape, and a combination thereof.

5. The method of claim 4, wherein said metal wire comprises a plurality of holes to anchor said one or more metal wire elements securely in said artificial stone.

6. The method of claim 1, wherein one or a combination of pressure, vibration, and a vacuum is applied on said deposited uncured artificial stone mix, whereby said deposited uncured artificial stone mix is compacted, and air entrapped in said deposited uncured artificial stone mix is released.

7. The method of claim 1, wherein said one or more metal wire elements are arranged in the form of metal grids of a plurality of patterns.
